(19) United States
(12) Patent Application Publication
(10) Pub. No.: US 2006/0270056 A1
(43) Pub. Date: Nov. 30, 2006

(54) Method and device for mass spectroscopy

(76) Inventors: Marten Stjernstrom, Danderyd (SE); Mattias Vangbo, Fremont, CA (US)

Correspondence Address: GE HEALTHCARE BIO-SCIENCES CORP.;PATENT DEPARTMENT, 800 CENTENNIAL AVENUE, PISCATAWAY, NJ, 08855, US

(21) Appl. No.: 10/538,399

(22) PCT Filed: Dec. 10, 2003
(86) PCT No.: PCT/EP03/14006

§ 371 Date: Jun. 5, 2006

(30) Foreign Application Priority Data
Dec. 11, 2002 (GB) 0228830.6

(51) Int. Cl. G01N 1/10

(52) U.S. Cl. 436/173; 436/174

(57) ABSTRACT

The present invention relates to mass spectrometer target slides (1) which are provided with pits (9a-9n) on the sample receiving surface (5). The sample receiving surface (5) and the rims (11a-11n) of the pit (9a-9n) are coated with a hydrophobic layer 17. The at least one pit (9a-9n) has a width or diameter Ø1 which is less than the width of a drop applied to the pit (9a-9n).

### FIELD OF THE INVENTION

The present invention relates to devices and methods of the type mentioned in the preambles of the independent claims for preparing targets performing matrix-assisted laser desorption/ionisation (MALDI) mass spectrometry.

### PRIOR ART

Matrix-assisted laser desorption/ionisation (MALDI) mass spectrometry is a method in which a crystallised matrix made of light-absorbing small molecules is excited by a short laser pulse that creates vibrational movement of the matrix molecules. This movement releases some of the matrix molecules at the surface, and embedded analyte molecules are also dragged out into the surrounding vacuum of the ion source. At some point during this process, a fraction of the analyte and matrix molecules gets singly ionised, and this fraction of molecules is accelerated out of the ion source for mass-to-charge ratio (M/Z) analysis, often in a time-of-flight (TOF) system.

Before being examined by MALDI mass spectroscopy the analyte being tested has to be prepared so that it is in a suitable form for MALDI mass spectroscopy. Typically it is prepared in the following way:

the analyte is added to a solution of laser light absorbing matrix;

droplets of the analyte/matrix mixture are then placed on a (stainless steel) MALDI target slide; and,

the solvent allowed to evaporate leaving spots of crystals of sample/matrix on the target slide.

In order to increase the limit of detection it is eligible to minimise the amount of matrix and gather all sample/matrix material to a small spot. This is can be achieved by having a hydrophobic target slide surface. However, a problem that occurs with such a method is that the droplets are not held onto a particular part of the target slide and can move around as the solvent evaporates) leaving the matrix residue at an undefined position. The result is that during mass spectroscopy large areas of the target slide give very little, or no, signal.

Consequently, the mass spectrometer (or the operator) needs to search for spots that give good signals, which is often done by using a camera-equipped mass spectrometer to visually locate crystals, or by just looking at the spectral quality of the mass spectrometer signal while moving the sample around. Neither method is entirely satisfactory as the first method requires the cost of the camera and the use of an operator to look for the sample spot while the second method may also require an operator and is time-consuming as, if the mass spectrometer is not equipped with means for viewing the target slide in situ, the only way of finding a spot is to systematically aim and fire the laser across the whole of the slide until a signal is received indicating that it has hit a spot.

### SUMMARY OF THE INVENTION

According to the present invention, at least some of the problems with the prior art are solved by means of a method having the features present in the characterising part of claim 1 and a device having the features mentioned in the characterising part of claim 5.

### BRIEF DESCRIPTION OF THE FIGURES

FIG. 1 a) shows schematically a plan view of a target slide in accordance with a first embodiment of the present invention;

FIG. 1b) shows a section along line A-A in FIG. 1a); and,

FIGS. 2 a)-2e) show schematically stages in the evaporation of solvent from a pit on a target slide in accordance with the present invention.

### DETAILED DESCRIPTION OF EMBODIMENT ILLUSTRATING THE INVENTION

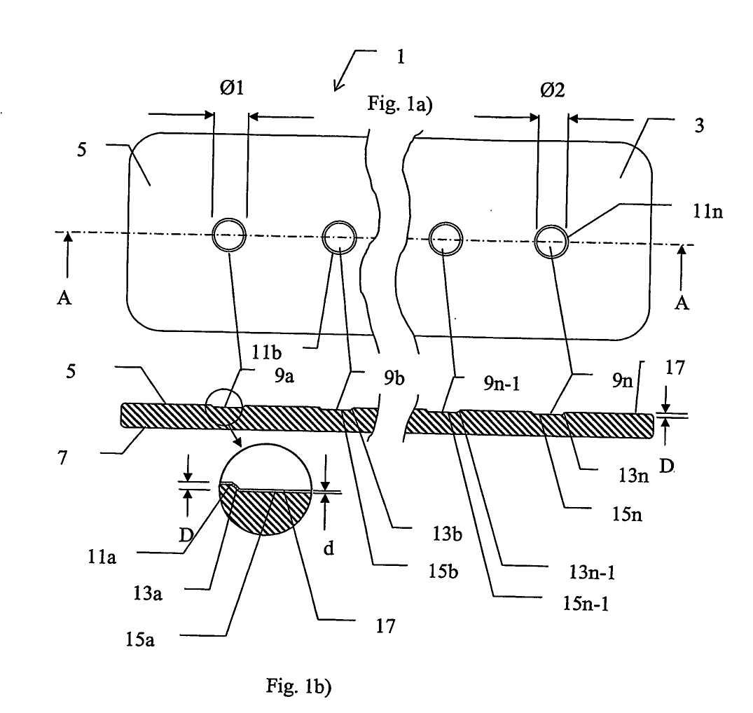

A first embodiment of a MALDI target slide 1 in accordance with the present invention is shown in FIGS. 1a) and 1b). Slide 1 comprises is in the shape of a rectangular thin substrate 3, preferably with rounded corners or ends. Substrate 3 may be typically of the order of 7.5 cm long, 8 mm wide and 0.5 mm thick and is made of a conducting material such as stainless steel. Substrate 3 has an upper, sample-receiving surface 5 intended to receive drops containing samples of analyte. Sample receiving surface 5 could be the whole of a surface of substrate 3 or may comprises one or more areas on a surface of said substrate, said areas being specially arranged to receive samples, e.g. by being specially treated (for example, by being coated with a hydrophobic material) or by being arranged in predetermined positions. Substrate 3 has a bottom surface 7 intended to rest on, or be held in, a sample mount in a MALDI mass spectrometer. The upper surface 3 is provided with at least one, preferably a plurality of, drop positioning pits 9a-9n. These pits are formed in the sample-receiving surface 5 by any suitable method, e.g. drilling, stamping, etching, ablation, sand blasting, (laser) cutting, milling, (hot) embossing, punching, casting, moulding, etc. The number n of pits can be any suitable number, e.g. 1, 2, 4, 8, 16, 32, 64, 96, 384, 1536 etc. These pits 9a-9n are circular and each have a rim 11a-11n with a diameter Ø1 (or maximum width W1 in the case of non-circular pits) which is preferably substantially smaller (e.g. less than half the diameter of the drop diameter Ødrop) than the diameter of a drop Ødrop when it is being applied, e.g. pipetted onto, to the slide 1. For example, for a drop with a diameter Ødrop of 1 mm, a suitable rim diameter Ø1 could be of in the range of 0.5 mm-0.05 mm, e.g. 0.18 mm. Each pit is preferably at least 5 μm deep and preferably is less than 0.1 mm deep. Pits 9a-9n may have vertical or sloping walls 13a-13n and, in the case of sloping walls the diameter Ø2 of the pit bottoms 15a-15n preferably is the same as or smaller that Ø1, e.g. 0.16 mm if Ø1 is 0.18 mm, in order to make it easier to manufacture. The upper surface 5 (at least in the region surrounding each pit) and pit rims 9a-9n are coated with a layer 17 of a hydrophobic material such as PTFE, or FEP or the like. Optionally pit walls 13a-13n and bottoms 15a-15n may also be coated by layer 17. Layer 17 can be deposited by any suitable method e.g. laminating, vapour deposition, dipping, spraying, painting, spin coating, or being left as an residue following evaporation of a carrier liquid after having been applied in solution or suspension in the carrier liquid, etc. Layer 17 is preferably thin, cracked or conductive enough to allow the de-coupling of interfering surface charge build-ups so that any negative influence on the functioning of the mass spectrometer caused by them is minimised. Preferably layer 17 is at least as thick as the thickness of a monolayer of the hydrophobic material and is less than 0.5 mm thick. Preferably layer 17 is a continuous layer.

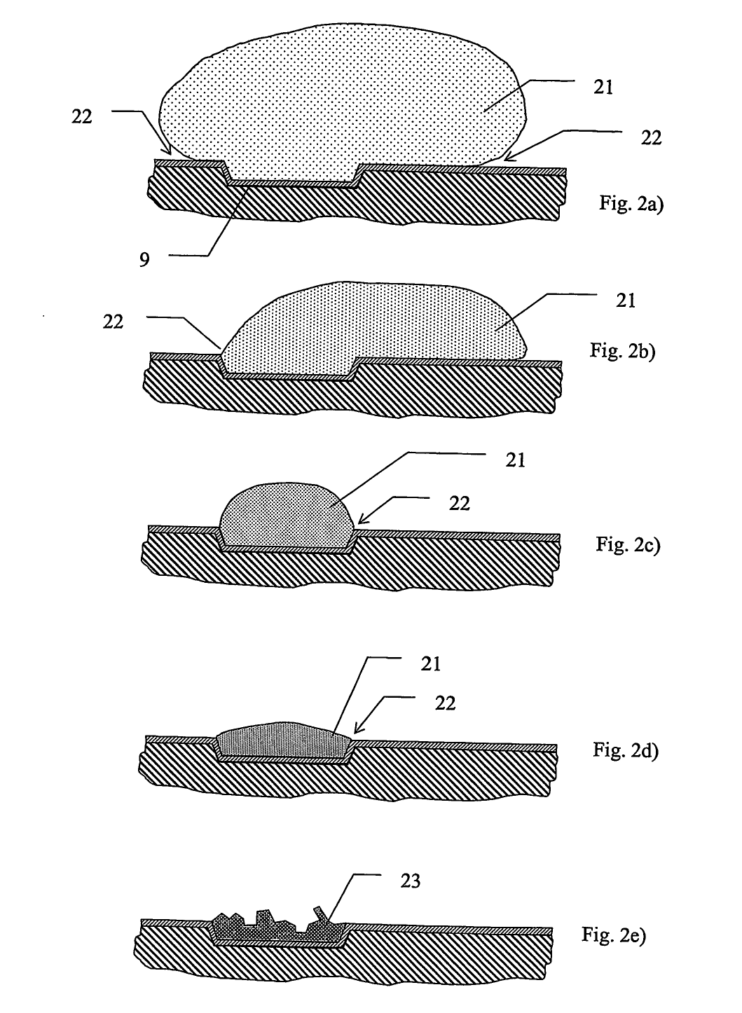

The use of a pit, which has a rim diameter (or width) which is smaller than the diameter of the drop being applied to it, means that the drop is anchored by a surface effect. This is illustrated in FIGS. 2a)-2e) which show schematically stages in the formation of crystals from a drop applied to a slide in accordance with the present invention. FIG. 2a) shows a drop 21 on a pit 9. FIG. 2b) shows the same drop after some of the liquid in the drop has evaporated and part of the liquid front 22 of the drop has reached the rim 11 of the pit 9. FIG. 2c) shows the same drop after some more of the liquid has evaporated and the liquid front is now the same size as, and in contact with, the rim 11 of the pit 9. At this point it is energetically disadvantageous for the liquid front to move over the rim 11 and descend the wall 13 of the pit 9. Instead, further evaporation just takes causes the height of the droplet to decrease as shown in FIG. 2d). This continues until the liquid eventually becomes saturated with the matrix material and crystals 23 are formed as shown in FIG. 2e).

While the invention has been illustrated by an example in which the pits are circular, any other shapes are also possible e.g. oval, quadratic or irregular shapes.

The size of the pits may be adjusted in accordance with the amount of matrix (and analyte) that it is intended to anchor. It is conceivable to provide a target slide in accordance with the present invention with a plurality of pits with different diameters (or maximum widths), e.g. some pits 0.5 mm wide, some pits 0.4 mm wide, some 0.37 mm wide, etc. When a drop of matrix and analyte is to be applied to a target slide in accordance with the present invention the user may select an appropriately sized pit to receive the drop. The preferred diameter or width of a pit may be chosen depending on the dry volume of the matrix and analyte in the drop. Preferably the amount of the matrix and analyte in a drop is adjusted, or the size of the pit selected, so that when the solvent evaporates the solid matrix and analyte crystals completely cover the bottom of a pit and more preferably so that the amount of matrix and analyte do not saturate the drop until enough solvent has evaporated for the drop to shrink so that its contact area with the surface is the same as the size of the pit.

The optimum size of a size of a pit depends, amongst other, on the amount of solid residue in a drop that it is intended to receive, the size of the overlap area of the laser spot that is used to excite the matrix material and the eye of the sampling ion optics, and also the number of times that the solid residue is intended to be excited by a laser. The optimum size pit for a drop containing a solid volume V of matrix material and analyte would have a maximum diameter (or maximum width) and shape which is exactly the same size as the laser spot/ion optics eye that will be used to excite and sample the matrix/analyte material. Furthermore, it will provide for the distribution of the matrix/analyte material to a surface density such that when the solid residue is analysed, for example by being excited 100 times by the laser, then when the analysis is finished, most, or all, of the solid residue has been ablated. In this way most or all of the analyte is sampled.

If the amount of matrix and analyte are not known then it could be practical to just use any pit that has a diameter or maximum width which is less than half the original diameter of the drop that that it is intended to anchor.

In order to be able to coat the pit with a layer of hydrophobic material, the pit should not be too small nor have a depth to width ratio which makes it difficult to reliably coat the pit walls (and bottom). Preferably a pit is less than 1 mm wide, more preferably less than 0.7 mm wide, even more preferably about 0.1-0.05 mm wide. Preferably a pit is shallow enough so that it does not unduly affect the electrical field that is used to accelerate the ions during operation of the mass spectrometer. Preferably a pit is less than 1 mm deep, more preferably less than 0.5 mm deep and most preferably less than 0.1 mm deep after the hydrophobic coating has been applied to it. As it is the rim of the pit which provides the surface effect that holds a drop in position, the actual depth of the pit does not influence the positioning of a drop once the drop has come into contact with the rim, and therefore the pit can be very shallow—even less than 5 μm deep for very small drops and correspondingly small pits e.g. pits less than about 0.25 mm wide. However, accurately forming such narrow pits may be expensive, therefore, for commercial reasons, it may be preferable to have pits which are deeper than theoretically necessary.

The thickness of the hydrophobic coating depends on the conductivity of the coating material used. It should be adapted so that the resistance through the coating is sufficiently low that it allows normal operation of the mass spectrometer that the slide is used in. As mentioned previously, it may be as thin as it is reliably possible to make e.g. less than 0.5 mm, preferably less than 100 μm and most preferably less than 10 μm. Molecular hydrophobic monolayers (i.e. layers which are the same depth as one molecule of hydrophobic material) are also conceivable—especially for disposable target slides where wear resistance is not an issue. Alternatively, the pits can be machined in a material that is hydrophobic by itself.

The above mentioned embodiments are merely intended to illustrate the present invention and are not intended to limit the scope of protection claimed by the following claims.

1. A method of preparing a target slide for mass spectroscopy analysis comprising the steps of: making at least one pit (9a-9n) which is less than 1 mm wide and having a wall (13a-13n) and a pit bottom (15a-15n) in a sample receiving surface (5) of a substrate (3) of the target slide (1), wherein there is a rim (11a-11n) between said sample receiving surface and said wall (13a-13n); and, making said sample receiving surface (5) and the rim (11a-11n) of said at least one pit (9a-9n) more hydrophobic than the substrate (3) of said target slide.

2. The method of claim 1 wherein said rim (11a-11n) is coated with a layer of hydrophobic material (17).

3. The method of claim 1, further comprising the step of making the pit bottom(s) (15a-15n) of said at least one pit (9a-9n) more hydrophobic than the substrate (3) of said target slide.

4. A target slide for use in a mass spectrometer comprising a substrate (3) having a sample receiving surface (5) including at least one pit (9a-9n) which is less than 1 mm wide and having a wall (13a-13n) and a pit bottom (15a-15n) in said sample receiving surface (5), wherein there is a rim (11a-11n) between said sample receiving surface and said wall (13a-13n), wherein said sample receiving surface (5) and the rim (11a-11n) of said at least one pit (9a-9n) are more hydrophobic than the substrate (3).

5. The target slide of claim 4, wherein said at least one pit is more than 0.05 mm wide.

6. The target slide of claim 4, wherein said at least one pit (9a-9n) is less than 100 μm deep.

7. The target slide of claim 4, wherein said at least one pit (9a-9n) is more than 5 μm deep.

8. The target slide of claim 4, comprising a substrate (3) of conducting material coated with a layer (17) of hydrophobic material.

9. The target slide of claim 8, wherein said layer (17) of hydrophobic material is less than 0.1 mm thick.

10. The target slide of claim 4, wherein said pit bottom (15a-15n) is more hydrophobic than the substrate (3).
